(19) United States
(12) Patent Application Publication
(10) Pub. No.: US 2014/0200961 A1
(43) Pub. Date: Jul. 17, 2014

(54) ELECTRONIC SYSTEM AND METHOD FOR MANAGING BIG GAME HARVESTING

(71) Applicants: Martin Folks, Coatesville, PA (US); Fabiano Lupo, West Chester, PA (US)

(72) Inventors: Martin Folks, Coatesville, PA (US); Fabiano Lupo, West Chester, PA (US)

(21) Appl. No.: 14/150,618

(22) Filed: Jan. 8, 2014

Related U.S. Application Data
(60) Provisional application No. 61/751,831, filed on Jan. 12, 2013.

(51) Int. Cl. G06Q 50/26; G06Q 30/02

(52) U.S. Cl. CPC G06Q 50/26; G06Q 30/0205
USPC 705/7.34

(57) ABSTRACT

A non-transitory machine-readable storage medium is provided. The medium has encoded thereon program code, wherein, when the program code is executed by a machine, the machine implements a method for managing the harvesting of a big game animal. The method includes the steps of selecting a jurisdiction; downloading a form from the jurisdiction, the form providing fillable fields for providing data about the harvesting the animal; filling out the form with the data; saving the data to a database; and providing the jurisdiction with access to the database.

### CROSS-REFERENCE TO RELATED APPLICATION

This application claims priority to U.S. Provisional Patent Application Ser. No. 61/751,831, filed Jan. 12, 2013, which is incorporated by reference herein in its entirety.

### FIELD OF THE INVENTION

The present invention relates to an electronic system and method used to track big game animals and to manage harvesting of the game animals.

### BACKGROUND OF THE INVENTION

The hunting of big-game, particularly on state game lands, is a large business, and helps state game commissions to manage big-game wildlife within their jurisdictions. Knowing the types and approximate amounts of big-game within their jurisdictions allow state game commission to regulate and manage the numbers of such big-game within the jurisdiction, such as, for example, by restricting the amount of hunting of a particular big-game if it appears that the big-game is becoming scarce, or by allowing additional hunting of the big-game if it appears that the big-game is becoming overpopulated.

Because of the wild nature of the big-game, it may be difficult for a state game commission to accurately determine the numbers and locations of big-game within their jurisdiction. It would be beneficial to provide hunters with an electronic means to report hunting results to their respective game commissions in order to help manage big-game populations. As an incentive to encourage hunters to electronically provide such information, it would also be beneficial to provide the hunters with features that may encourage them to use such electronic means, including, but not limited to, license applications, navigation information, and emergency assistance.

### BRIEF SUMMARY OF THE INVENTION

Briefly, the present invention provides a method comprising her the steps of receiving a jurisdiction selection from an electronic device, the jurisdiction being selected from a plurality of jurisdictions in a first database; uploading an electronic form from a second database to the electronic device, the second database being related to the selected jurisdiction, the electronic form providing fillable fields for providing data about the harvesting of an animal; receiving the form, the form including the data; saving the data to the second database; and providing the selected jurisdiction with access to only the second database.

The present invention also provides a non-transitory machine-readable storage medium, having encoded thereon program code, wherein, when the program code is executed by a machine, the machine implements the method for managing the harvesting of a big game animal described above.

Additionally, the present invention also provides a system including the non-transitory machine-readable storage medium and a tag attached to an animal. The tag contains about the animal such that, when the tag scanned by an electronic scanning device, the tag electronically transmits information about the animal to the non-transitory machine-readable storage medium.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is an operational chart illustrating the structure and operation of a system and method for harvesting big game according to a first exemplary embodiment of the present invention;

FIG. 2 is an exemplary graphical user interface (GUI) of a home/login page for the system of FIG. 1;

FIG. 3 is an exemplary GUI of a “Logout” page for the system of FIG. 1;

FIG. 4 is an exemplary data input GUI for a new user of the system of FIG. 1;

FIG. 5 is an exemplary GUI of kill information for the system of FIG. 1;

FIG. 6 is exemplary GUI of new kill information for the system of FIG. 1;

FIG. 6A is exemplary GUI of a turkey harvest report card used in the system of FIG. 1;

FIG. 6B is exemplary GUI of a deer harvest report card used in the system of FIG. 1;

FIGS. 7-10 are exemplary GUI's of data input wheels used in the system of FIG. 1;

FIG. 11 is an exemplary GUI of a map used in the system of FIG. 1;

FIG. 12 is an exemplary GUI of a calendar used in the system FIG. 1; and

FIG. 13 is an exemplary GUI of seasonal hunting details used in the system FIG. 1.

### DETAILED DESCRIPTION OF THE INVENTION

In the drawings, like numerals indicate like elements throughout. Certain terminology is used in the following description for convenience only and is not limiting. The terminology includes the words above specifically mentioned, derivatives thereof and words of similar import. The embodiments described and illustrated below are not intended to be exhaustive or to limit the invention to the precise form disclosed. These embodiments are chosen and described to best explain the principle of the invention and its application and practical use and to enable others skilled in the art to best utilize the invention.

The present invention is electronic application that may be accessed via a mobile or wireless electronic device, such as, for example, a cell phone, a laptop computer, or any other electronic device that can be used to access and transmit information electronically, as recognized by those having ordinary skill in the art. The application may be written using iOS platform Software Development Kit (SDK) and may be backwards compatible to electronic devices running prior versions of iOS.

The inventive application may be used by hunters in the field and/or state game commission to track and manage the harvesting of big game. As used herein, “big game” is defined as any type of game that is managed by a state game commission and/or requires a state hunting license to hunt. Exemplary embodiments of big-game, which are by no means limiting, include deer, elk, caribou, moose, turkeys, and bears. Additionally, fish may be included as a non-limiting example of a species that may be tracked and managed using the present invention.

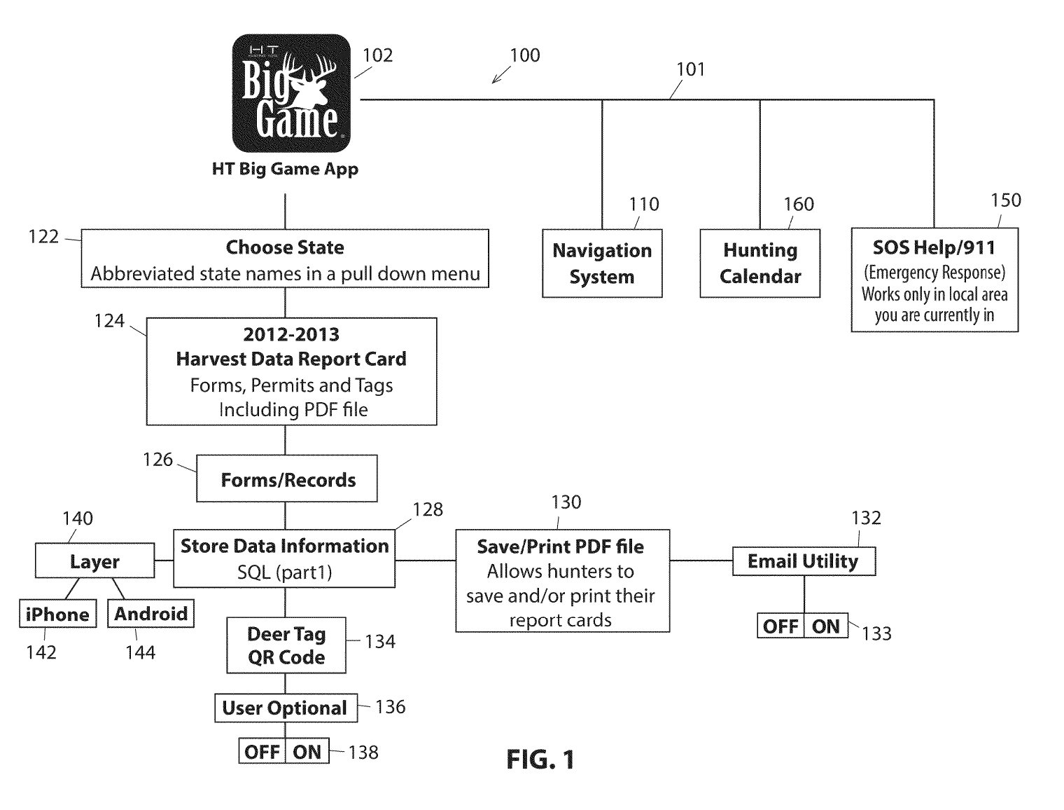

Referring to FIG. 1, an exemplary operational chart 101 illustrating the structure and operational flow of the electronic application 100 of the present invention is shown. Operational chart 101 includes a homepage 102 that allows the user to select one of several features of the invention. Exemplary features include a navigation module 110, a big-game management module 120, and an emergency module 150. Those skilled in the art will recognize that additional modules (not shown) can be added to application 100 and accessed via homepage 102.

Application 100 can be provided to a user as part of the purchase of a hunting license a particular state. The state licensing authority can provide an access code for the user to obtain the proper application 100 associated with that state to ensure that all of the information required by that state and available through application 100 is provided to the user the application 100.

Big game management module 120 can be tailored according to individual states, in accordance with each individual state's hunting and big-game management laws. A user selects an appropriate state in “Choose State” block 122, which generates a drop-down menu listing each state. If information for a particular state is not available through application 100, that state's name or abbreviation is printed in a different color or font, to indicate to the user that that state's information is not available.

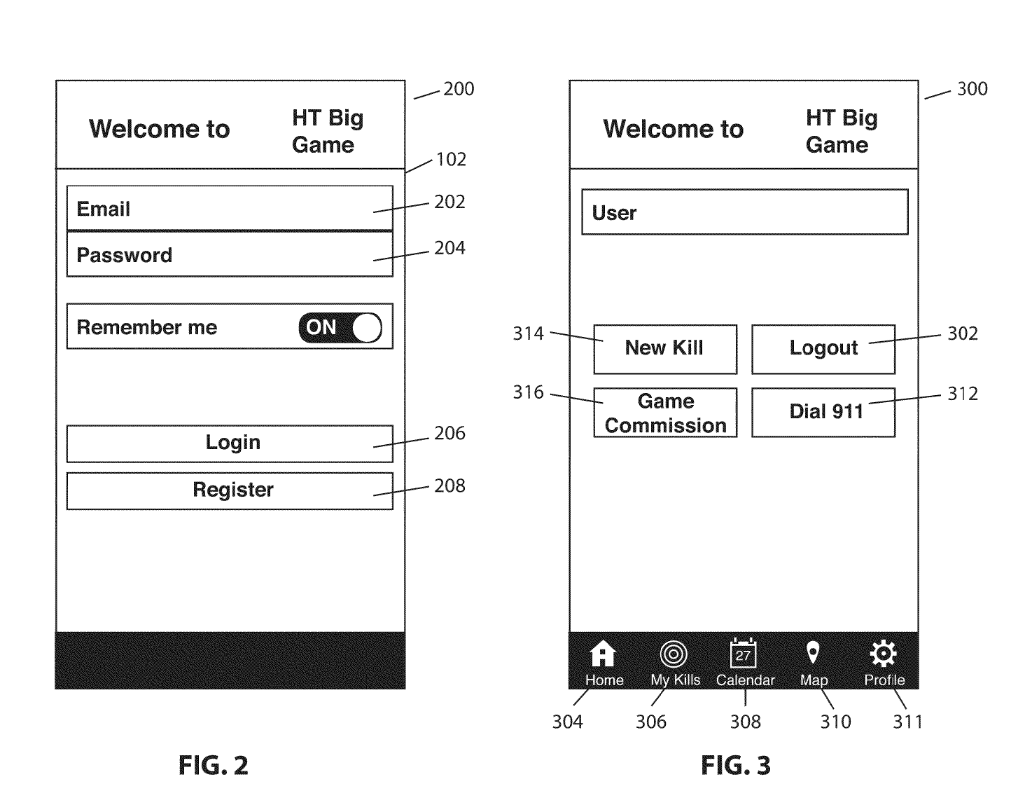

Referring now to FIG. 2, exemplary graphical user interface (GUI) 200 of homepage 102 is displayed. Homepage 102 is generated when the user starts application 100. Homepage 102 allows the user to enter his username and password in blocks 202 and 204, respectively and to login by pressing “Login” button 206. Pressing login button 206 generates GUI 300, shown FIG. 3. If the user desires to logout from application 100, the user presses “Logout” button 302, which will return the user to GUI 200, shown FIG. 2.

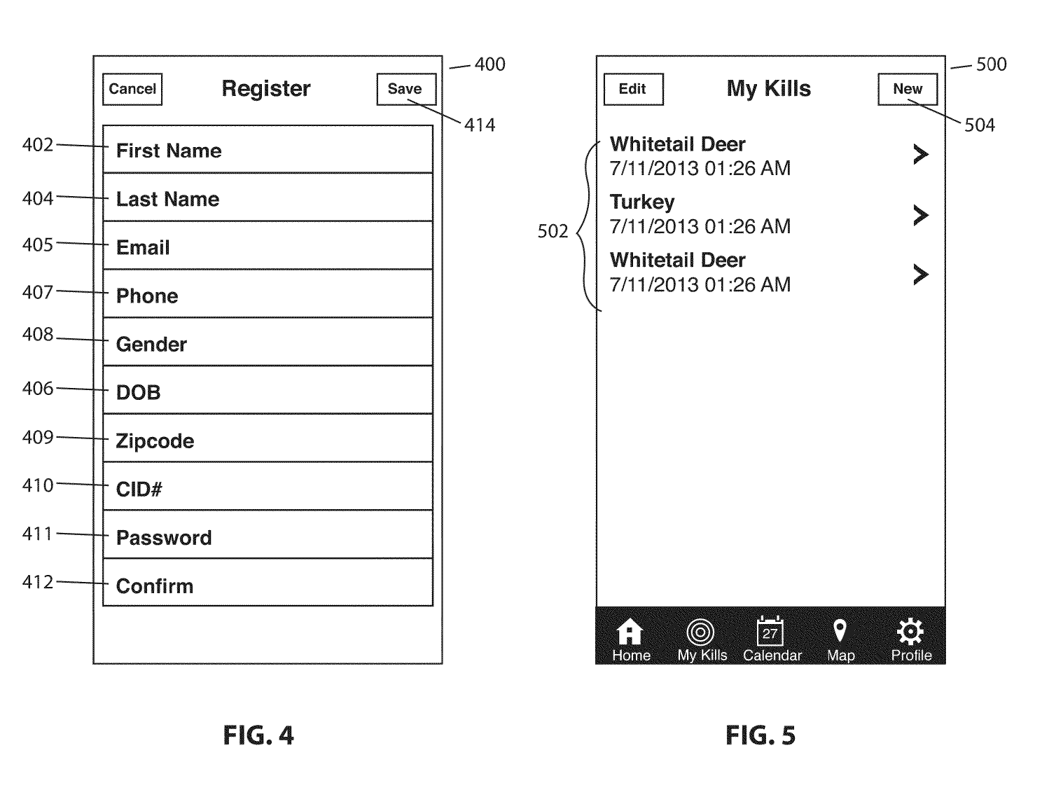

Referring back FIG. 2, if the user is a new user, the user presses “New User” button 208, which generates GUI 400, shown FIG. 4. GUI 400 includes input boxes 402-412 to allow the user to input their first name, last name, Email, birthdate, phone number, gender, zip code, CID number, password, and password confirmation, respectively. After inputting this information, the user can click on “Save” button 414, which inputs the user's information into the system database and generates GUI 300, shown FIG. 3.

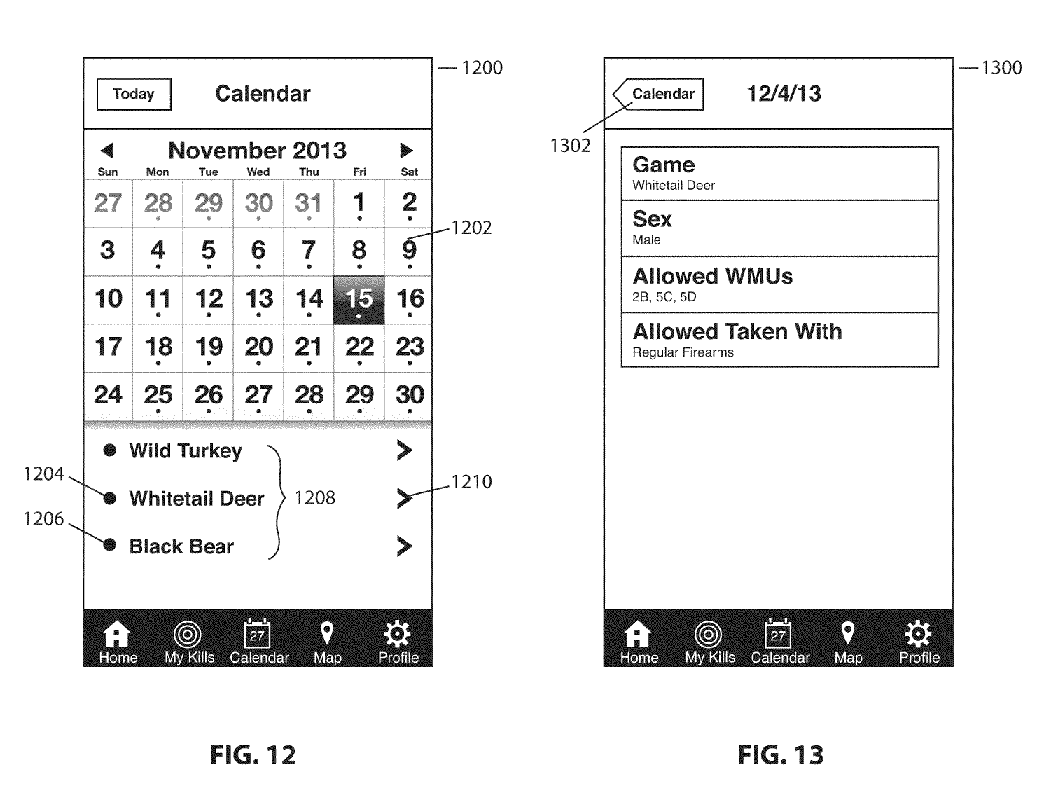

From GUI 300, the user can click on one of several different buttons to generate different screens and access different portions of application 100. For example, if the user clicks on “Home” button 304, then GUI 300, shown in FIG. 3 is generated. Alternatively, if user clicks on “My Kills” button 306, application 100 generates GUI 500, shown FIG. 5. If user clicks on “Calendar” button 308, application 100 generates GUI 1200, shown in FIG. 12. If user clicks on “Map” button 310, application 100 generates GUI 1100, shown in FIG. 11. If user clicks on “Profile” button 311, application 100 generates GUI 400, shown in FIG. 4. If the user clicks on the “Game Commission” button 316, the website for the state game commission associated with the zip code entered into block 409 is displayed.

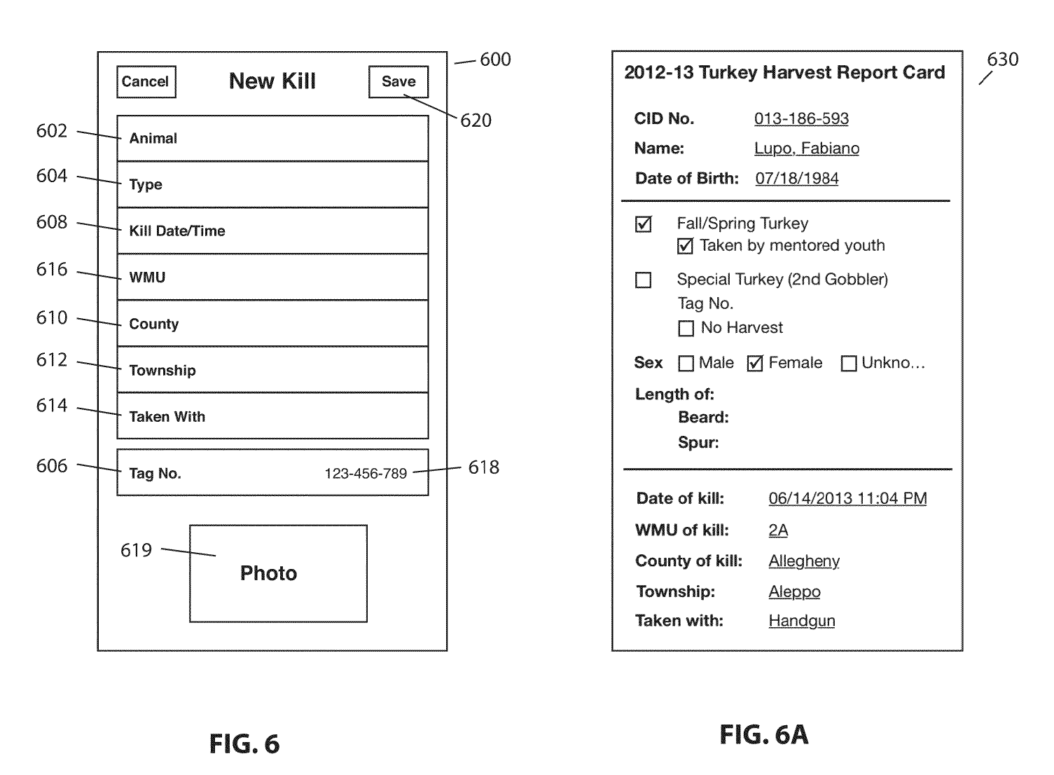

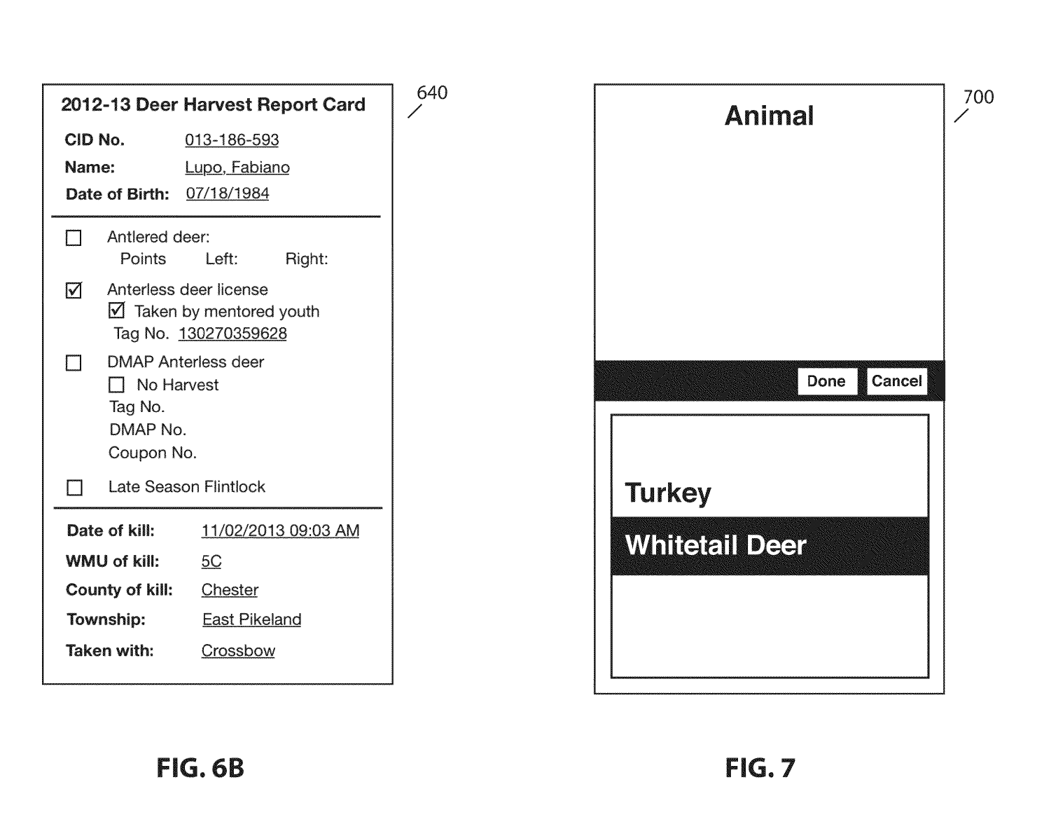

GUI 500 provides a listing 502 of big-game that had been previously killed by the user, along with the date of the kill. To input a new kill, the user clicks on “New” button 504 (or “New Kill” button 314, shown in FIG. 3), which generates GUI 600, shown FIG. 6.

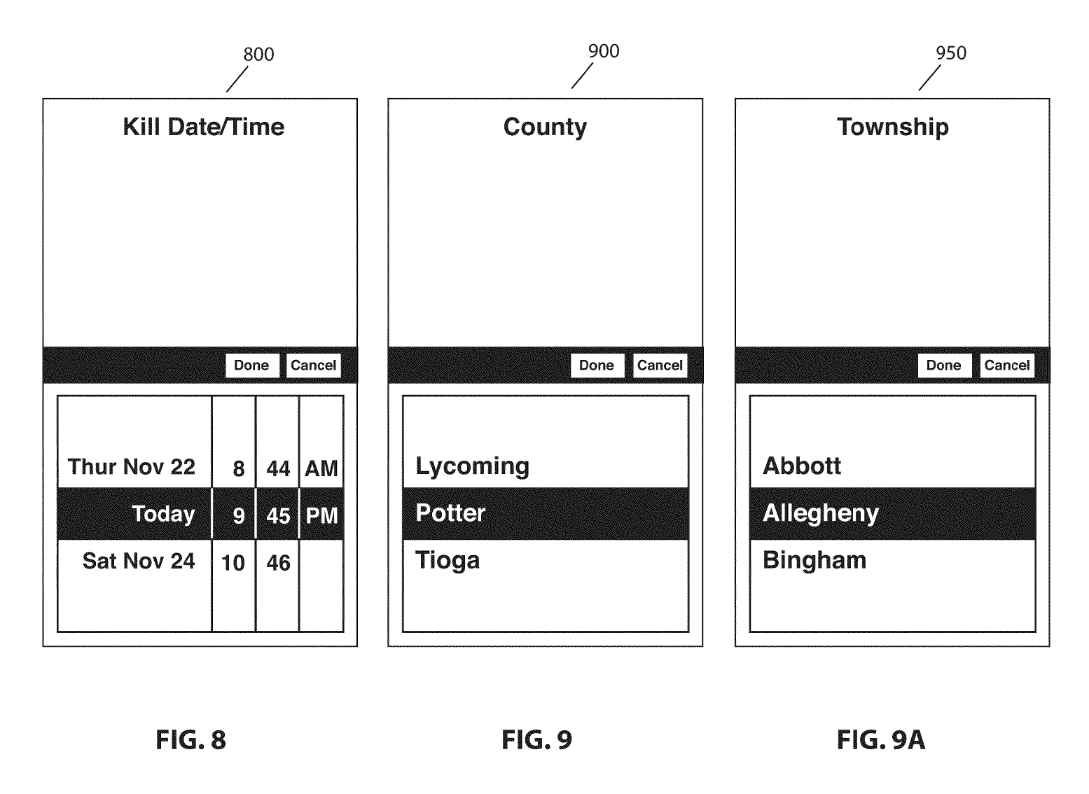

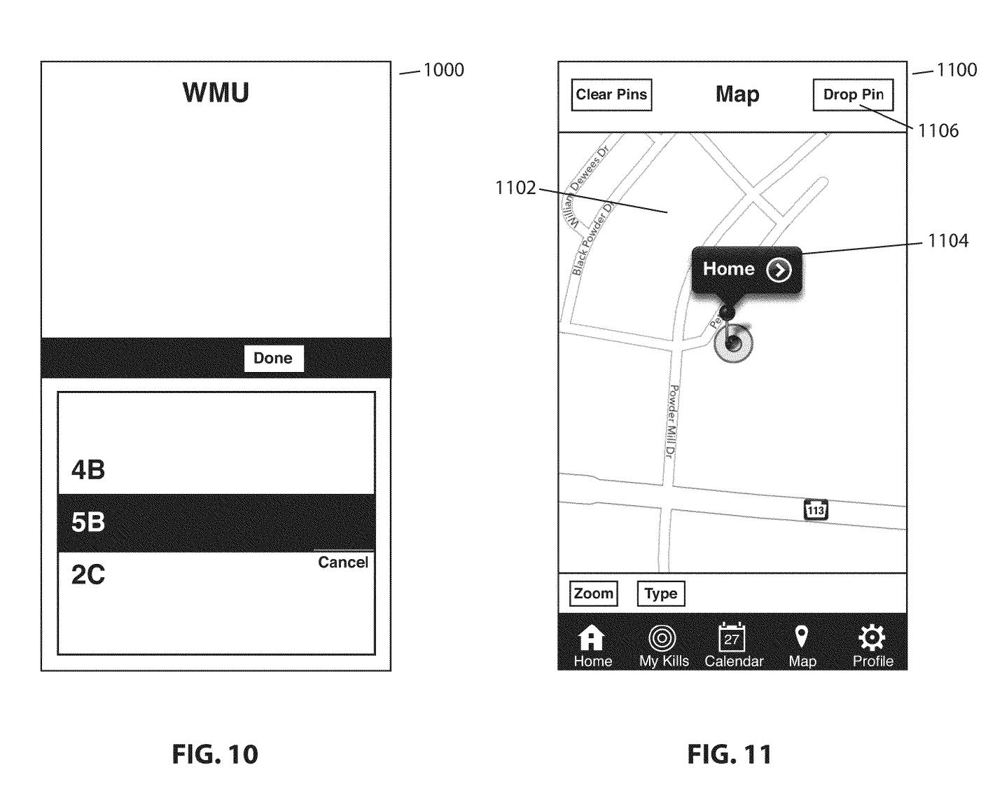

GUI 600 provides a listing of data information 602-616 required about the kill, including, for example, the type of animal, the animal sex, the hunters tag number, the kill date, the County of the kill, the Township of the kill, the type of weapon that the kill was taken with, and the wildlife management unit (WMU), which is a designated zone within the particular state. GUI 600 is provided with arrows 618 that are associated with each of the data information listings. When the user clicks on a particular arrow 618, a corresponding wheel selector, such as those shown in GUI 700, 800, 900, 950, 1000 in FIGS. 7, 8, 9, 9A, and 10, respectively, for data information 602, 608, 610, 612, and 616 is generated. The user operates the generated wheel selector to select the appropriate information and then clicks on the “Save” button 620, shown FIG. 6.

If the user's GPS system is activated on the user's mobile device, location information, such as County, Township, and WMU can be automatically filled in when the user clicks “Save” button 620. After the user clicks on the “Save” button 620, the information from GUI 600 is wirelessly transmitted to database 128 (shown FIG. 1) where the information is electronically stored. Additionally, application 100 then generates GUI 500, where the new kill information is displayed.

Further, prior to submitting the kill information, the user can use his/her wireless device to take a photo of himself/herself with the kill to provide a photographic record of the kill. Such a photograph may be transmitted by the application 100 to the particular state game commission. The user clicks on “PHOTO” block 619 to select the desired photo from the user's mobile device. When the user clicks on the “Submit” button 620, the photo is transmitted with the remainder of the information 602-616 about the kill.

Alternatively, instead of inputting kill information into GUI 600, a particular state may require a “Harvest Data Report Card”. Exemplary Harvest Data Report Cards are shown in FIGS. 6A and 6B. Referring back to FIG. 1, to satisfy this requirement, application 100 may generate a “Harvest Data Report Card” as shown in block 124. The Harvest Data Report Card includes forms, permits, and tags, shown in block 126, required for hunters in the particular state. Exemplary forms can include a “Turkey Harvest Report Card” 630, shown in FIG. 6A and a “Deer Harvest Report Card” 640, shown in FIG. 6B. Those skilled in the art will recognize that other formats for Harvest Data Report Cards can be used.

The information requested on each of the Turkey Harvest Report Card and the Deer Harvest Report Card includes information about the Hunter, such as his/her hunting license number, name, and date of birth, as well as information about the game that was harvested. For example, for the Turkey Harvest Report Card 630, information requested includes the type of turkey and its gender as well as the length of the turkey's beard and spur. For the Deer Harvest Report Card 640, information requested includes whether the deer is antlerless or antlered and, if antlered, how many points on the left and right antlers. Additional information requested on both of the cards includes the data the kill and the location, including the county and township of the kill and the type of weapon used to make the kill.

All of the cards are provided in editable PDF format which allows the user to fill out the required information directly on the user's mobile device and electronically transmit the form, with the data, to application 100. Application 100 receives the form with the data, which is stored in block 128 in an SQL database. In addition to data about the game animal, the data can also include information about the hunter/sender, such as, for example, hunting license information, so that the hunter/sender can be identified.

In block 130, the user can save the information to the SQL database and/or print the information for their file. The user has the option, in block 132 to e-mail the information to the state game commission if the user selects “ON” in block 133. Alternatively, if the user selects “OFF” in block 133, the user will have to forward the printed information to the game commission at a later date.

For game that has been harvested, the state game commission may have already tagged the game in block 134 with an electronic Quick Response (“QR”) code that has been attached to the game, such as on one of the game's ears. The hunter has the option in block 136 to scan the QR code if the user selects “ON” in block 138. If the hunter does scan the QR code with his/her mobile device, i information contained in the QR code is transmitted to and received by the database in block 128 to provide information about the game to the state game commission. Such information can be valuable to the state game commission and includes information about where the game was harvested relative to where the game was initially tagged. This information can provide the state game commission with migration pattern information about the game. For example, if the game was originally tagged in Wind Gap, Pa. and harvested two years later in Kunkletown, Pa., such data can provide valuable information to the state game commission about the migration pattern of the game. Further, because application 100 includes GPS information in navigation module 110, scanning of the QR code can also transmit the exact location of the harvest rather than rely on the hunter to provide an approximate location (Township/County) when filling out the harvest report card. Such information can be used to assist the state game commission in game management. Application 100 provides each participating state with access to the data stored in SQL block 128 relative to that state only.

Alternatively, if the user selects “OFF” in block 138, the QR code is not scanned and the information embedded in the QR code is not transmitted to the database in SQL database block 128. A “Layer” block 140 allows application 100 to be used on either an iPhone 142 or an Android 144. Layer block 140 provides the required interface with SQL database block 128.

If the user desires to use navigation module 110, user clicks on globe icon 308 at the bottom of GUI 500. Clicking on globe icon 308 generates GUI 1100, shown in FIG. 11. GUI 1100 includes an area map 1102 showing the general location of the user and a balloon 1104 highlights the user's more exact location. GUI 1100 also includes a “Drop Pin” button 1106 that allows a user to “drop” an electronic pin at a location on map 1102. Multiple pins may be dropped to track a path that the user takes along the map. The path may be used by the user to retrace his/her steps after hunting, or to ensure that the user takes an alternate route back to his/her starting point. Additionally, multi-colored pins may be used to distinguish different items on map 1102. For example, a brown pin might be used to denote the location of animal droppings, which may enable the user to determine areas frequented by certain types of game. A blue pin might be used to denote the location of a tree stand, a black pin might denote the location of a trap, and a red pin might be used to denote the location of a kill.

Navigation module 110 incorporates a navigation system and a compass feature as well as area maps. Navigation module can include a Global Positioning System (GPS) module incorporated therein. GPS systems are well-known and widely available on modular and portable electronic devices, such as cell phones, and do not need to be described in detail herein. Similarly, the area map 1102 can incorporate maps generated by such known services as Google Earth, MapQuest, or other services, such as maps of state game lands. Exemplary maps of, for example, Pennsylvania state game lands, are available through the Pennsylvania Game Commission website, wwwpgc,state.pa.us. Alternatively, other sources of maps can be provided for area map 1102. Navigation module 110 uses the GPS system to superimpose location balloon 1104 onto area map 1102.

Referring back to FIG. 3, a hunting calendar icon 310 can be pressed by the user to generate a hunting calendar GUI 1200, shown FIG. 12 and to access Hunting Calendar module 160, shown FIG. 1. Hunting Calendar GUI 1200 provides a calendar 1202 that lists the time periods during which particular game is allowed to be hunted and with what type of weapon (rifle, bow and arrow, etc.).

GUI 1202 includes color-coded icons, such as icons 1204, 1206 along with a code key 1208 that allow the user to see which game may be hunted on which dates. Further, arrows 1210, which are associated with each icon 1204, 1206 can be clicked on to access details about the particular animal. For example, clicking on arrow 1210 associated with Black Bear icon 1204 will generate GUI 1300, shown FIG. 13. GUI 1300 provides information that the animal, such as the animal type, the WN you location where the animal may be harvested, and restrictions about harvesting the animal, such as the number of animals that may be harvested during a license year, the type of weapon that may be used to harvest the animal, and other pertinent details. A “Calendar” button 1302 can be clicked to return the user to GUI 1200.

Because different states have different time periods for hunting game, the data that is displayed to the user when hunting calendar icon 310 is selected depends on the state chosen by the user.

Emergency module 150 provides an “SOS Help” or “911” feature that allows the user to quickly access in order to summon a local emergency response team in the event of an emergency. The user merely clicks on a “Dial 911” button 312, shown in GUI 300 in FIG. 3. Using the embedded GPS and navigation module 110, module 150 transmits a wireless electronic signal to a local emergency response team, providing the location of the user through the GPS. Known commercial GPS location technology, such as that used by OnStar, Life Alert, LoJack, or other commercial vendors may be used. Alternatively, a separately developed GPS location technology can be used.

Additional features provided by application 100, and which can be accessed by clicking on icons, such as icons 304-311 from FIG. 3, may include local weather forecast, safety tips, the locations of businesses that may be associated with the hunting industry, such as, for example taxidermist, butchers, hospitals etc. or other businesses that a hunter may need to/desire to patronize as part of the hunting experience, or other features that may be added to application 100.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A method comprising the steps of:
(a) receiving a jurisdiction selection from an electronic device, the jurisdiction being selected from a plurality of jurisdictions in a first database;
(b) uploading an electronic form from a second database to the electronic device, the second database being related to the selected jurisdiction, the electronic form providing fillable fields for providing data about the harvesting of an animal;
(c) receiving the form, the form including the data;
(d) saving the data to the second database; and
(e) providing the selected jurisdiction with access to only the second database.

2. The method according to claim 1, wherein the second database is a subset of the first database.

3. The method according to claim 1, wherein step (c) further comprises receiving data from a tag attached to the animal.

4. The method according to claim 1, wherein the data comprises hunting license application information.

5. The method according to claim 1, wherein the data comprises information about a killed animal.

6. The method according to claim 1, wherein step (c) further comprises receiving the form electronically.

7. The method according to claim 1, prior to step (a), receiving user information from the electronic device.

8. A non-transitory machine-readable storage medium, having encoded thereon program code, wherein, when the program code is executed by a machine, the machine implements a method for managing the harvesting of a big game animal, the method comprising the steps of:
(a) receiving a jurisdiction selection from an electronic device, the jurisdiction being selected from a plurality of jurisdictions in a first database;
(b) uploading an electronic form from a second database to the electronic device, the second database being related to the selected jurisdiction, the electronic form providing fillable fields for providing data about the harvesting of an animal;
(c) receiving the form, the form including the data;
(d) saving the data to the second database; and
(e) providing the selected jurisdiction with access to only the second database.

9. The non-transitory machine-readable storage medium according to claim 8, wherein the second database is a subset of the first database.

10. The non-transitory machine-readable storage medium according to claim 8, wherein step (c) further comprises receiving data from a tag attached to the animal.

11. The non-transitory machine-readable storage medium according to claim 8, wherein the data comprises hunting license application information.

12. The non-transitory machine-readable storage medium according to claim 8, wherein the data comprises information about a killed animal.

13. The non-transitory machine-readable storage medium according to claim 8, wherein step (c) further comprises receiving the form electronically.

14. The non-transitory machine-readable storage medium according to claim 8, further comprising, prior to step (a), receiving user information from the electronic device.

15. The non-transitory machine-readable storage medium according to claim 8, wherein the method further comprises the step of providing a navigation system.

16. The non-transitory machine-readable storage medium according to claim 8, wherein the method further comprises the step of providing an electronic calendar listing available dates to legally harvest the animal.

17. The non-transitory machine-readable storage medium according to claim 8, wherein the method further comprises the step of receiving an emergency response request.

18. The non-transitory machine-readable storage medium according to claim 8, wherein the fillable fields further comprise a hunting license application request.

19. A system comprising:
a non-transitory machine-readable storage medium, having encoded thereon program code, wherein, when the program code is executed by a machine, the machine implements a method for managing the harvesting of a big game animal, the method comprising the steps of:
(a) receiving a jurisdiction selection from an electronic device, the jurisdiction being selected from a plurality of jurisdictions in a first database;
(b) uploading an electronic form from a second database to the electronic device, the second database being related to the selected jurisdiction, the electronic form providing fillable fields for providing data about the harvesting of an animal;
(c) receiving the form, the form including the data;
(d) saving the data to the second database; and
(e) providing the selected jurisdiction with access to only the second database; and
a tag attached to an animal, the tag containing information about the animal such that, when the tag scanned by an electronic scanning device, the tag electronically transmits information about the animal to the non-transitory machine-readable storage medium.

20. The system according claim 19, wherein the information about the animal is transmitted to the second database.
